(19) United States
(12) Patent Application Publication
(10) Pub. No.: US 2019/0320417 A1
(43) Pub. Date: Oct. 17, 2019

(54) METHOD, SYSTEM AND APPARATUS

(71) Applicant: NOKIA SOLUTIONS AND NETWORKS OY, Espoo (FI)

(72) Inventor: Yang Liu, Beijing (CN)

(21) Appl. No.: 15/774,545

(22) PCT Filed: Dec. 10, 2015
(86) PCT No.: PCT/CN2015/097011

§ 371 Date: May 8, 2018

(51) Int. Cl. H04W 72/04

(52) U.S. Cl. CPC H04W 72/04; H04W 92/20

(57) ABSTRACT

There is provided a method comprising a method comprising receiving , from a first access point at a second access point, bearer identity information, said bearer identity information comprising an indication of at least one identity value associated with a respective first bearer of a user device, the user device capable of operating using dual connectivity mode, allocating, in dependence on the bearer identity information, an identity value associated with a second bearer for operating in dual connectivity with the user device, wherein data carried on the second bearer is split at the second access point and using the allocated identity value to configure the user device with the second bearer.

### FIELD

The present application relates to a method, apparatus, system and computer program and in particular but not exclusively to dual-connectivity and a method of differentiation between split bearers.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems. A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. The LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimising the 3GPP LTE radio access technologies. Another example network is a 5G communication network.

### SUMMARY

There is provided, in a first aspect a method comprising receiving, from a first access point at a second access point, bearer identity information, said bearer identity information comprising an indication of at least one identity value associated with a respective first bearer of a user device, the user device capable of operating using dual connectivity mode, allocating, in dependence on the bearer identity information, an identity value associated with a second bearer for operating in dual connectivity with the user device, wherein data carried on the second bearer is split at the second access point and using the allocated identity value to configure the user device with the second bearer.

Allocating the identity value associated with the second bearer may comprise determining an identity value distinct from the identity value associated with the first bearer and the identity value associated with the second bearer.

Using the allocated identity value to configure the user device with the second bearer may comprise providing an indication of the allocated identity value to the first access point for use in configuring the user device with the second bearer.

Using the allocated identity value to configure the user device with the second bearer may comprise providing an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In a second aspect, there is provided a method comprising providing, from a first access point to a second access point, bearer identity information, said bearer identity information comprising an indication of at least one identity value associated with a respective first bearer of a user device , the user device capable of operating using dual connectivity mode, receiving, from the second access point, an indication of an allocated identity value associated with a second bearer, the identity value associated with the second bearer allocated in dependence on the bearer identity information, wherein data carried on the second bearer is split at the second access point and using the allocated identity value to configure the user device with the second bearer.

Using the allocated identity value to configure the user device with the second bearer may comprise determining whether the allocated identity value is distinct from the identity value associated with the respective first bearer.

Using the allocated identity value to configure the user device with the second bearer may comprise providing an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In a third aspect, there is provided an apparatus, said apparatus comprising means for receiving, from a first access point at a second access point, bearer identity information, said bearer identity information comprising an indication of at least one identity value associated with a respective first bearer of a user device, the user device capable of operating using dual connectivity mode, means for allocating, in dependence on the bearer identity information, an identity value associated with a second bearer for operating in dual connectivity with the useir device, wherein data carried on the second bearer is split at the second access point and means for using the allocated identity value to configure the user device with the second bearer.

Means for allocating the identity value associated with the second bearer may comprise means for determining an identity value distinct from the identity value associated with the first bearer and the identity value associated with the second bearer.

Means for using the allocated identity value to configure the user device with the second bearer may comprise means for providing an indication of the allocated identity value to the first access point for use in configuring the user device with the second bearer.

Means for using the allocated identity value to configure the user device with the second bearer may comprise means for providing an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In a fourth aspect there is provided an apparatus, said apparatus comprising means for providing, from a first access point to a second access point, bearer identity information, said bearer identity information comprising an indication of at least one identity value associated with a respective first bearer of a user device, the user device capable of operating using dual connectivity mode, means for receiving, from the second access point, an indication of an allocated identity value associated with a second bearer, the identity value associated with the second bearer allocated in dependence on the bearer identity information, wherein data carried on the second bearer is split at the second access point and means for using the allocated identity value to configure the user device with the second bearer.

Means for using the allocated identity value to configure the user device with the second bearer may comprise means for determining whether the allocated identity value is distinct from the identity value associated with the respective first bearer.

Means for using the allocated identity value to configure the user device with the second bearer may comprise means for providing an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In a fifth aspect, there is provided an apparatus comprising at least one processor and at least one memory including a computer program code, the at least one memory and the computer program code configured to, with the at least one processor, cause the apparatus at least to receive, from a first access point at a second access point, bearer identity information, said bearer identity information comprising an indication of at least one identity value associated with a respective first bearer of a user device, the user device capable of operating using dual connectivity mode, allocate, in dependence on the bearer identity information, an identity value associated with a second bearer for operating in dual connectivity with the user device, wherein data carried on the second bearer is split at the second access point and use the allocated identity value to configure the user device with the second bearer.

The apparatus may be configured to determine an identity value distinct from the identity value associated with the first bearer and the identity value associated with the second bearer.

The apparatus may be configured to provide an indication of the allocated identity value to the first access point for use in configuring the user device with the second bearer.

The apparatus may be configured to provide an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In a sixth aspect, there is provided an apparatus comprising at least one processor and at least one memory including a computer program code, the at least one memory and the computer program code configured to, with the at least one processor, cause the apparatus at least to provide, from a first access point to a second access point, bearer identity information, said bearer identity information comprising an indication of at least one identity value associated with a respective first bearer of a user device, the user device capable of operating using dual connectivity mode, receive, from the second access point, an indication of an allocated identity value associated with a second bearer, the identity value associated with the second bearer allocated in dependence on the bearer identity information, wherein data carried on the second bearer is split at the second access point and use the allocated identity value to configure the user device with the second bearer.

The apparatus may be configured to determine whether the allocated identity value is distinct from the identity value associated with the respective first bearer.

The apparatus may be configured to provide an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In a seventh aspect there is provided a computer program embodied on a non-transitory computer-readable storage medium, the computer program comprising program code for controlling a process to execute a process, the process comprising receiving, from a first access point at a second access point, bearer identity information, said bearer identity information comprising an indication of at least one identity value associated with a respective first bearer of a user device, the user device capable of operating using dual connectivity mode, allocating, in dependence on the bearer identity information, an identity value associated with a second bearer for operating in dual connectivity with the user device, wherein data carried on the second bearer is split at the second access point and using the allocated identity value to configure the user device with the second bearer.

Allocating the identity value associated with the second bearer may comprise determining an identity value distinct from the identity value associated with the first bearer and the identity value associated with the second bearer.

Using the allocated identity value to configure the user device with the second bearer may comprise providing an indication of the allocated identity value to the first access point for use in configuring the user device with the second bearer.

Using the allocated identity value to configure the user device with the second bearer may comprise providing an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In an eighth aspect there is provided a computer program embodied on a non-transitory computer-readable storage medium, the computer program comprising program code for controlling a process to execute a process, the process comprising providing, from a first access point to a second access point, bearer identity information, said bearer identity information comprising an indication of at least one identity value associated with a respective first bearer of a user device , the user device capable of operating using dual connectivity mode, receiving, from the second access point, an indication of an allocated identity value associated with a second bearer, the identity value associated with the second bearer allocated in dependence on the bearer identity information, wherein data carried on the second bearer is split at the second access point and using the allocated identity value to configure the user device with the second bearer.

Using the allocated identity value to configure the user device with the second bearer may comprise determining whether the allocated identity value is distinct from the identity value associated with the respective first bearer.

Using the allocated identity value to configure the user device with the second bearer may comprise providing an indication of the allocated identity value and the associated bearer to the user device.

The identity values may comprise logical channel identity values.

Each of the respective first and second bearer may be associated with a respective security key.

Data carried on the respective first bearer may be split at the first access point.

The respective first bearer may be one of a master cell group bearer and a secondary cell group bearer.

The first access point may be a master nodeB. The second access point may be a secondary NodeB.

In a ninth aspect there is provided a computer program product for a computer, comprising software code portions for performing the steps the method of the first aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows a schematic diagram of a control plane architecture for eNBs involved in dual connectivity;

FIG. 4 shows a schematic diagram of a user plane architecture for eNBs involved in dual connectivity;

FIG. 5 shows a schematic diagram of user plane architecture for four bearer alternatives in dual connectivity;

FIG. 6 shows a schematic diagram of an example dual connectivity protocol architecture;

FIG. 7 shows a schematic diagram of a communications network using dual connectivity;

FIG. 8 shows a flowchart of an example method according to embodiments;

FIG. 9 shows a flowchart of an example method according to embodiments;

FIG. 10 shows an example signalling diagram for use in an embodiment;

FIG. 11 shows a schematic diagram of an example control apparatus;

### DETAILED DESCRIPTION

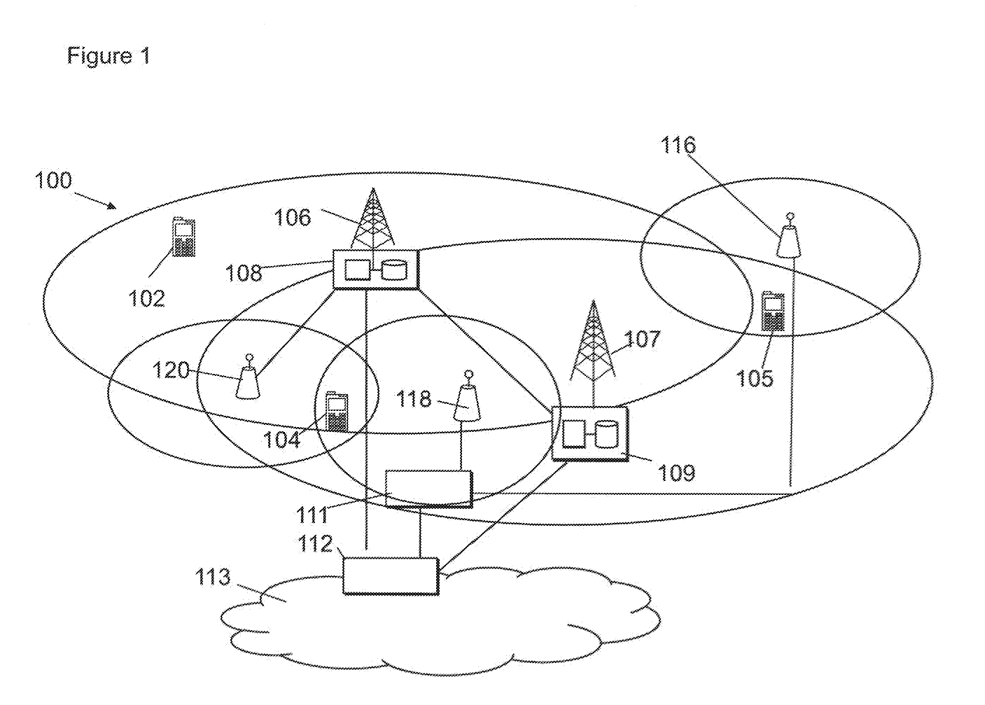

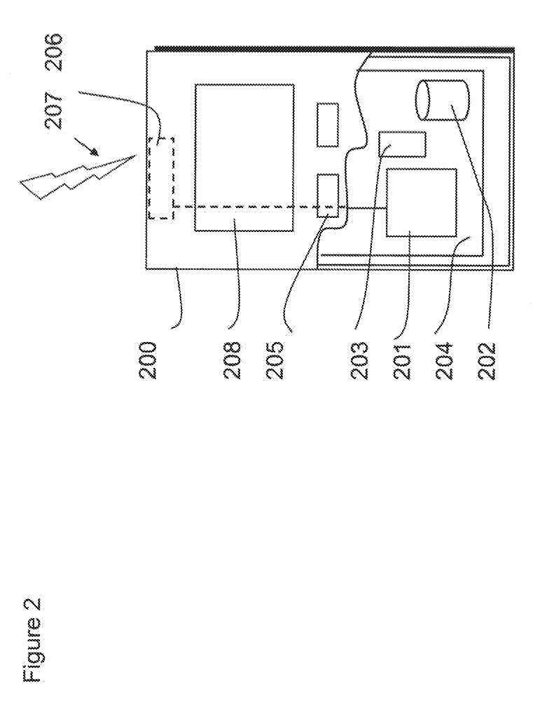

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs.

Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200.

Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Another example of a suitable communications system is the 5G concept. Network architecture in 5G may be quite similar to that of the LTE-advanced. Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. 5G may use multiple input—multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks will most probably utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent

The following is described with reference to dual connectivity (DC). Dual connectivity is a mode of operation of a UE in connected, e.g. RRC_CONNECTED, mode. The UE is configured with a master cell group (MCG) and a secondary cell group (SCG). In DC, a given UE consumes radio resources provided by at least two network points, e.g. Master and Secondary eNBs of the MCG and the SCG, respectively, connected with non-ideal backhaul. Dual connectivity may achieve improved inter-site carrier aggregation performance across cells connected via non-ideal-backhaul.

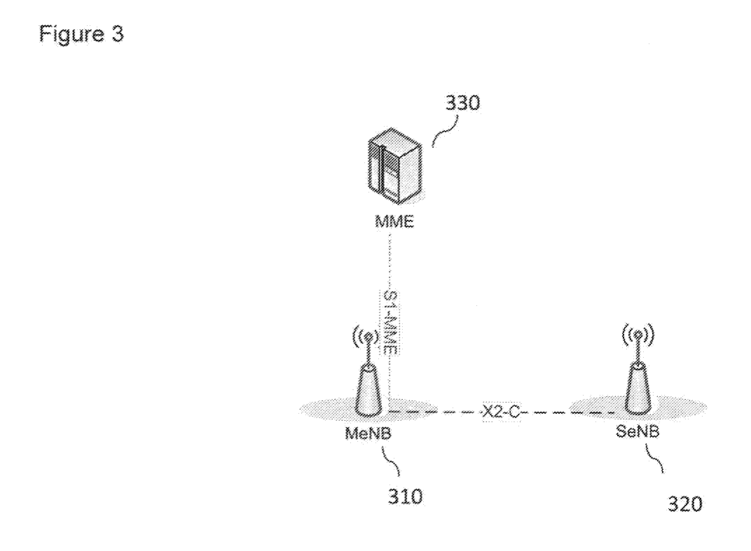

FIG. 3 shows a schematic diagram of an example control plane (C-Plane) architecture of eNBs 310 and 320 involved in dual connectivity. The interface between the MeNB 310 and the MME 330 is S1-MME. The interface between the MeNB 310 and the SeNB 320 is X2-C.

In dual connectivity, three types of bearers may be used. MCG bearers, split bearers and SCG bearers. For MCG bearers, the master eNB (MeNB) is user plane (U-plane) connected to the S-GW via S1-U, the secondary eNB (SeNB) is not involved in the transport of user plane data. For SCG bearers, the SeNB is directly connected with the S-GW via S1-U. For split bearers, the MeNB is U-plane connected to the S-GW via S1-U and the MeNB and the SeNB are interconnected via X2-U.

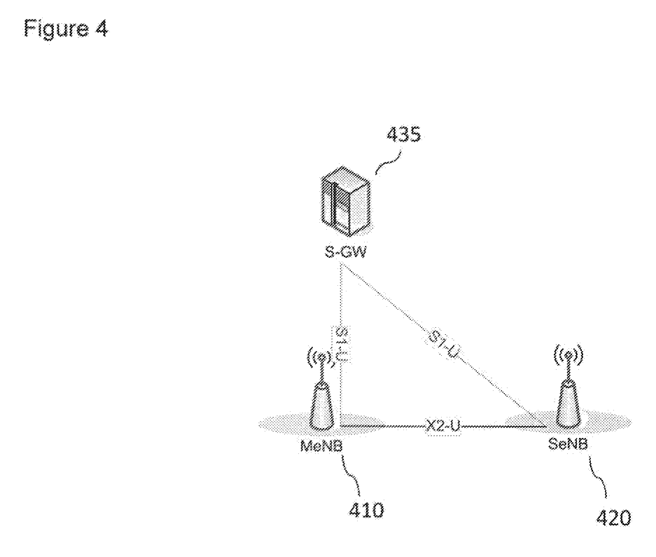

FIG. 4 shows a schematic diagram of an example U-plane architecture of eNBs 410 and 420 involved in dual connectivity with MCG bearers and SCG bearers. The interface between the MeNB 410 and the S-GW 430, and between the SeNB 420 and the S-GW 430 is S1-U. The interface between the MeNB 410 and the SeNB 420 is X2-U.

For split bearers in dual connectivity, data from the same radio bearer can be transmitted from both nodes involved in dual connectivity, which may be a macro eNB and a small cell eNB. The S1-U, S1-MME and the RRC protocols are terminated at the same node, which may be the MeNB. The MeNB can either be a macro cell or a small cell, though it may be preferable that a macro cell operates as the MeNB to avoid exposing small cell mobility to the core network (since the S1-MME is also terminated in the MeNB).

In a first split bearer solution such as that described above, a single eNB (the MeNB) is designated as the network node that terminates the RRC protocol towards the UE, as well as the S1-U and S1-MME connections from the core network. Terminating S1-MME and RRC at the macro eNB may provide improved coverage and mobility robustness. In this example dual connectivity architecture, S1-U is terminated at the same node that terminates the S1-MME and RRC protocols.

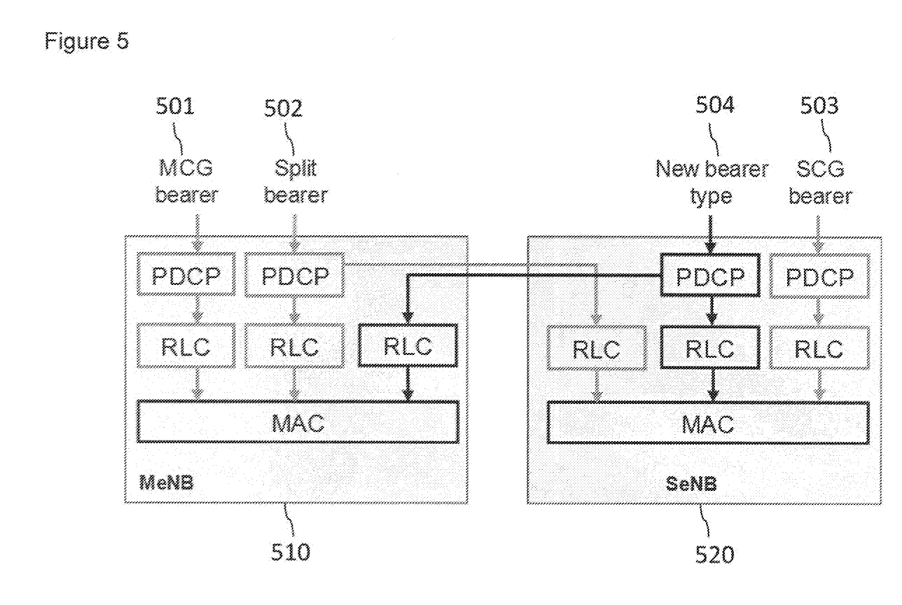

FIG. 5 shows example user plane protocol architecture for a legacy bearer (MCG bearer) 501, a first, or legacy, split bearer 502, an offloaded bearer (SCG bearer) 503 and a second split bearer 504.

In a second split bearer solution, as illustrated by bearer type 504 in FIG. 5, the data is split at the SeNB while S1-AP and RRC are located in MeNB. A core network (CN) perceives the split bearer as an SCG bearer. A UE may perceive the bearer type as a split bearer, with SeNB associated security (instead of MeNB security). There may be an impact in the X2 interface if MeNB signals a data split and forwarding configuration to SeNB in, e.g., the SeNB addition request. The SeNB may utilize radio resources to improve throughput gains without further burdening the MeNB's backhaul (S1-U) interface.

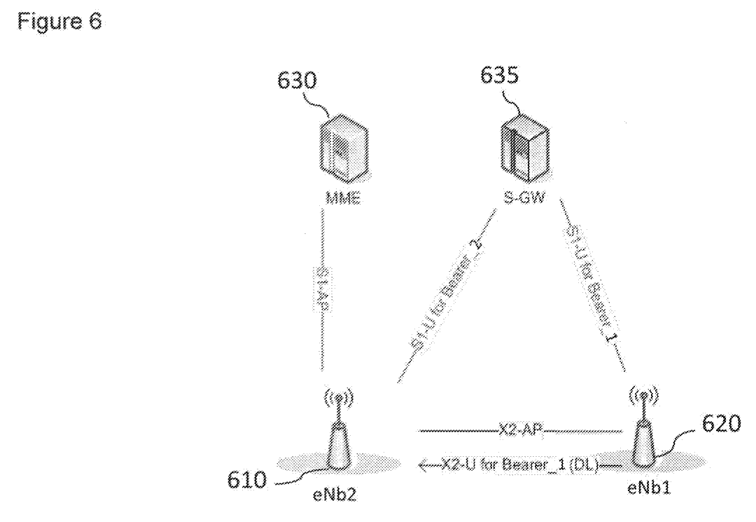

FIG. 6 shows a schematic diagram of an example user plane architecture for a bearer split at the SeNB, S1-U for the second split bearer type is terminated in the SeNB 620 while RRC and S1-MME with MME 630 are both terminated in the MeNB 610. MeNB 610 may control maintaining the RRC connection, configuring and managing the RRM measurements, etc. However, since PDCP is terminated in the SeNB 620, the second bearer type requires separate security keys at the MeNB 610 and at the SeNB 620 as for SCG bearers.

Logical channel identity (LCID) may be used to differentiate different bearers in UE. Each bearer may have an associated security key. For example, in legacy DC, MCG bearer and a legacy split bearer may be allocated different data radio bearer (DRB) identities and different LCIDs, so that when a UE receives packet data convergence protocol (PDCP) protocol data units (PDU) from a network, the UE may recognize which security keys (eNB key (KeNB) or SeNB key (S-KeNB)) to use based on the LCID of the PDU. A UE may receive an indication of the mapping between the LCID and the bearer via network configuration so the UE is aware of which security key to use in depended on the LCID information.

KeNB is assumed to be used for user plane (UP) traffic received from MeNB, e.g. MCG bearer and split bearer in MeNB, and S-KeNB is assumed to be used for UP traffic received from SeNB, e.g. SCG bearer and split bearer in SeNB (second split bearer type). The KeNB and S-KeNB are separate security keys from the control plane security keys.

Current specifications may not accommodate a combination of SCG bearer and split bearer in DC. If there is an ongoing SCG bearer, no split bearer would be present such that a UE could treat everything from SeNB with S-KeNB, and treat everything from MeNB with KeNB, without any differentiation efforts. However, given the second split bearer at the SeNB as described with reference to FIGS. 5 and 6, there may be a combinations of the bearer types in future with one UE, e.g. combination of any one of MCG bearer, SCG bearer, legacy split bearer and second split bearer at SeNB. For example, two types of split bearers, the legacy split bearer and the second split bearer, where data is split at the SeNB, may arrive at the same time at the same UE.

The split bearer at SeNB is managed and controlled by the SeNB. That is, the LCID for the second split bearer is allocated by SeNB. The MeNB allocates LCID for MCG bearer, and legacy split bearer but SeNB will be responsible for allocating the LCID for split bearer at the SeNB. From a network perspective, the LCID for each bearer is allocated respectively in

MeNB (for legacy split bearer) or in SeNB (second split bearer), hence the MeNB and SeNB may allocate the same LCID for different bearers.

A UE not aware of the mapping between bearer identities and LCID, may not able to identify the correct security keys used for a received PDU (since the UE may not be able to differentiate the security keys between different split bearers). The UE may thus not be able to decipher the UP traffic with correct security keys.

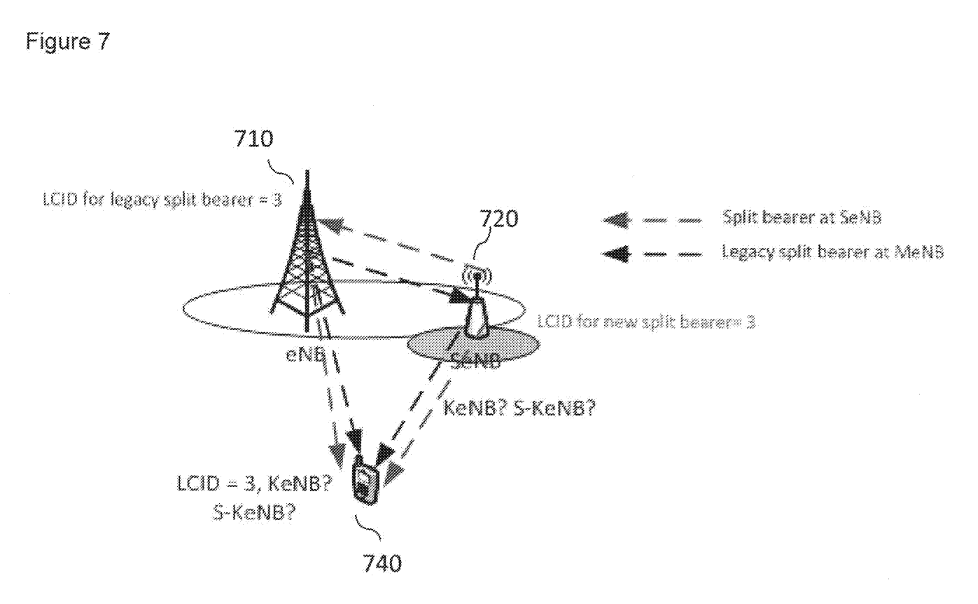

FIG. 7 shows a scenario in which an MeNB 710 and an SeNB 720 are both allocated the same LCID, “3”, for a legacy bearer and a bearer split at the SeNB 720, respectively. If a UE 740 identifies the received PDCP PDU as having LCID 3, the UE 740 should use related security keys for deciphering the PDCP PDU. However, in this case both the split bearer at SeNB and legacy bearer are mapped to the same LCID. Hence, the UE 740 may not be able to determine the correct security key to decipher the data since both of the security keys are effectively associated with the same LCID.

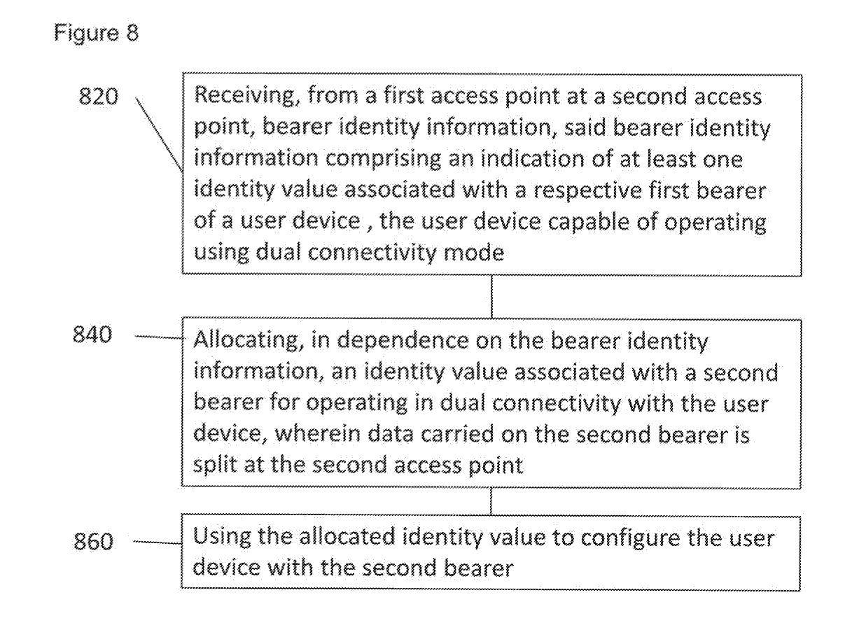

FIG. 8 shows a flowchart of an example method of LCID allocation for bearers. In a first step 820, the method comprises receiving, from a first access point at a second access point, bearer identity information, said bearer identity information comprising an indication of at least one identity value associated with a respective first bearer of a user device, the user device capable of operating using dual connectivity mode.

In a second step 840, the method comprises allocating, in dependence on the bearer identity information, an identity value associated with a second bearer for operating in dual connectivity with the user device, wherein data carried on the second bearer is split at the second access point.

In a third step 860, the method comprises using the allocated identity value to configure the user device with the second bearer.

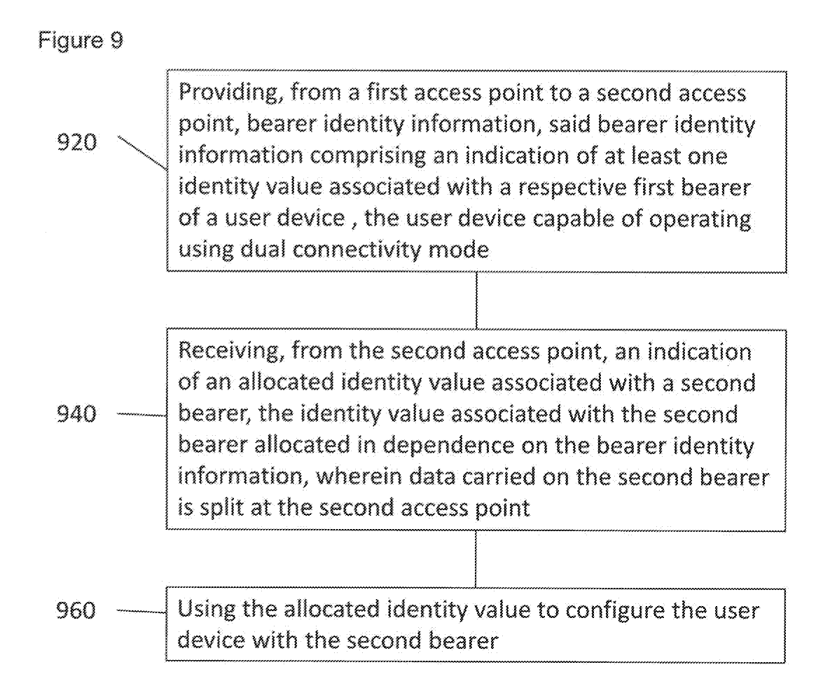

FIG. 9 shows a flowchart of an example method of LCID allocation for bearers. In a first step 920, the method comprises providing, from a first access point to a second access point, bearer identity information, said bearer identity information comprising an indication of at least one identity value associated with a respective first bearer of a user device, the user device capable of operating using dual connectivity mode.

In a second step 940, the method comprises receiving, from the second access point, an indication of an allocated identity value associated with a second bearer, the identity value associated with the second bearer allocated in dependence on the bearer identity information, wherein data carried on the second bearer is split at the second access point.

In a third step 960, the method comprises using the allocated identity value to configure the user device with the second bearer.

The first access point may be a MeNB. The second access point may be a SeNB.

The second bearer may be a split bearer split at the SeNB as described with reference to FIG. 5. The first access point may provide two identity values, each associated with a respective first bearer. The respective first bearer may comprise one of a MCG bearer, an SCG bearer and a legacy split bearer. Each respective first and second bearer may be associated with a security key, e.g. MCG bearer and legacy split bearer may be associated with KeNB and SCG bearer and bearer split at the SeNB may be associated with S-KeNB.

The identity values may comprises LCIDs.

The first access point or the second access point may use the allocated identity value to configure the user device with the second bearer. Using the allocated identity value to configure the user device with the second bearer may comprise providing, from the second access point, an indication of the allocated identity value to the first access point for use by the first access point in configuring the user device with second bearer. The first access point may determine whether the allocated identity value is distinct from the identity value associated with the respective first bearer.

Using the allocated identity value to configure the user device with the second bearer may comprise providing an indication of the allocated identity value to the user device from the first access point or the second access point.

In a method as described with reference to FIGS. 8 and 9, an SeNB may coordinate the LCID allocation for the second split bearer at SeNB with an MeNB, and may avoid overlapping of LCID between MeNB and SeNB for different split bearers. The MeNB may configure the mapping between the bearers and the LCIDs to the UE such that the UE may use the LCIDs to distinguish between the bearers and determine the correct security keys for DC operation.

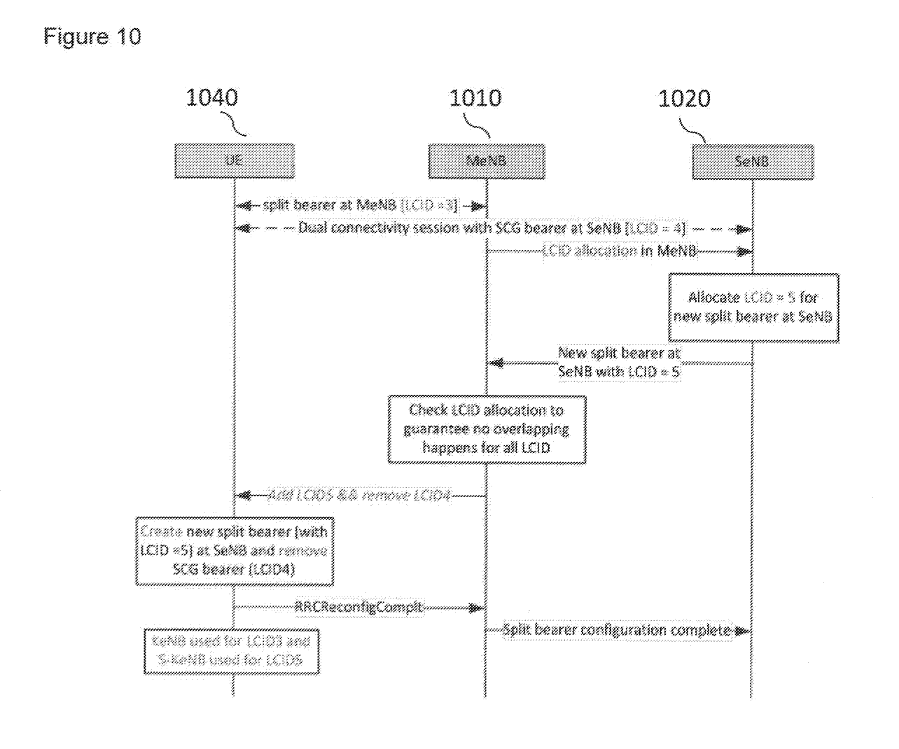

FIG. 10 shows an example signalling flow between MeNB 1010, SeNB 1020 and UE 1040 which may be used in the establishment of a split bearer at the SeNB in accordance with an embodiment.

In this example, two respective first bearers, legacy split bearer and SCG bearer, are setup in a first access point, MeNB 1010, and second access point, SeNB 1020, respectively. The UE 1040 is operating in DC mode with the legacy split bearer and SCG bearer as ongoing bearers. LCID 3 is allocated for split bearer at MeNB 1010, LCID 4 is allocated for SCG bearer in SeNB 1020. When UE 1040 receives PDCP PDUs from SeNB 1020, it may differentiate different packets based on LCID and determine which security key will be used to decipher the traffic in the respective bearers. UE 1040 may be provided with the mapping between the respective LCID and legacy split bearer/SCG bearer via network configuration. Hence, UE 1040 knows to use KeNB for PDU received via LCID3 and S-KeNB for PDU received via LCID4.

The bearer identity information may comprise an LCID allocation list, i.e. an indication of at least one identity value, such as an LCID value, associated with a respective first bearer of a user device. The first access point, e.g. MeNB 1010, provides the LCID allocation list towards the second access point, e.g., SeNB 1020. The LCID allocation list may comprise LCID allocated for all ongoing bearers between UE 1040 and network

In the example shown in FIG. 10, LCID3 is used for split bearer at MeNB 1010 and LCID4 is used for SCG bearer at SeNB 1020. The LCIDs for the split bearer at MeNB and SCG bearer may have been allocated using a similar method as that described with reference to FIGS. 8 and 9, wherein the first access point is the SeNB and the first bearer is the SCG bearer and the second access point is the MeNB and the second bearer is the split bearer at MeNB.

In the next step as shown in FIG. 10, if the SeNB 1020 decides to establish the second split bearer at SeNB 1020, the SeNB 1020 may allocate, in dependence on the bearer identity information, an identity value associated with the second split bearer, e.g. by determining the LCID allocation for the second split bearer in dependence on the allocation list provided by the MeNB 1010. The SeNB 1020 may allocate an LCID for the second split bearer, e.g. LCID5. The SeNB 1020 provides the MeNB 1010 with information indicating the allocation.

The MeNB 1010 may use the allocated identity value to configure the user device with the second bearer. Configuring the user device with the second bearer may comprise determining whether the allocated identity value is distinct from the identity value associated with the respective first bearer. For example, the MeNB 1010 may determine that the LCID allocations for the bearers to be used in DC do not overlap, such that the UE 1040 is able to differentiate different data flows from the same network node.

Configuring the user device with the second bearer may comprise providing an indication of the allocated identity value and the associated bearer to the user device. The MeNB 1010 may configure the UE with second split bearer type, with new DRB identity, together with the associated LCID, e.g. LCID5. The MeNB 1010 may remove LCID4 (SCG bearer) from UE 1040, since the SCG bearer will be changed to second split bearer from radio perspective. Although the MeNB 1010 has been described as performing the configuration of the user device with the second bearer, alternatively, or in addition, the configuration may be performed by the SeNB 1020. For example, the SeNB 1020 may provide an indication of the allocated identity value and the associated bearer to the user device

After UE 1040 replies ACK to network, from the UE perspective the UE 1040 is capable of mapping KeNB to LCID3 for legacy split bearer at MeNB 1010, and S-KeNB to LCID5 for the second split bearer at SeNB 1020. When PDCP PDU is received at the UE 1040 from MeNB 1010/SeNB 1020, UE 1040 may then be capable of determining the correct security keys for a given bearer based on the logical channel identity, to derive the UP traffic.

A UE may be able to distinguish between bearers and to use the correct security keys based on the received mapping of LCIDs and associated bearers from network side. Hence, the split bearer at the SeNB may be used to improve the throughput gains without involving MeNB's backhaul, which will relieve the burden of S1-U of MeNB for an increased number of DC UEs deployed in later LTE phase or 5G.

It should be understood that each block of the flowchart of FIGS. 8 and 9 and any combination thereof may be implemented by various means or their combinations, such as hardware, software, firmware, one or more processors and/or circuitry.

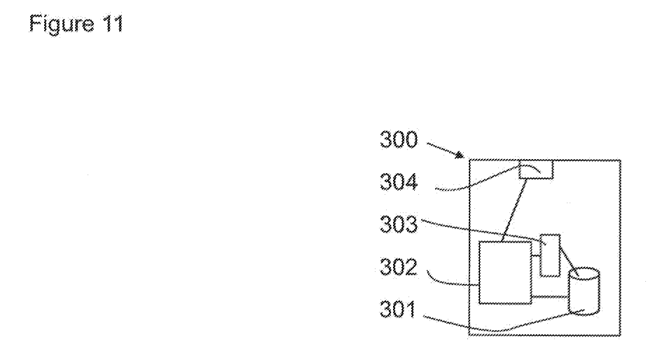

The method may be implemented on a mobile device as described with respect to FIG. 2 or control apparatus as shown in FIG. 11. FIG. 11 shows an example of a control apparatus for a communication system, for example to be coupled to and/or for controlling a station of an access system, such as a RAN node, e.g. a base station, (e) node B or 5G AP, or a node of a core network such as an MME or S-GW, or a server or host. The method may be implanted in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 can be configured to execute an appropriate software code to provide the control functions. Control functions may comprise receiving, from a first access point at a second access point, bearer identity information, said bearer identity information comprising an indication of at least one identity value associated with a respective first bearer of a user device, the user device capable of operating using dual connectivity mode, allocating, in dependence on the bearer identity information, an identity value associated with a second bearer for operating in dual connectivity with the user device, wherein data carried on the second bearer is split at the second access point and using the allocated identity value to configure the user device with the second bearer.

Alternatively, or in addition, control functions may comprise providing, from a first access point to a second access point, bearer identity information, said bearer identity information comprising an indication of at least one identity value associated with a respective first bearer of a user device, the user device capable of operating using dual connectivity mode, receiving, from the second access point, an indication of an allocated identity value associated with a second bearer, the identity value associated with the second bearer allocated in dependence on the bearer identity information, wherein data carried on the second bearer is split at the second access point and using the allocated identity value to configure the user device with the second bearer.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to LTE/LTE-A similar principles can be applied in relation to other networks and communication systems, for example, 5G networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process.

Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
receiving, from a first access point at a second access point, bearer identity information, said bearer identity information comprising an indication of at least one identity value associated with a respective first bearer of a user device, the user device capable of operating using dual connectivity mode;
allocating, in dependence on the bearer identity information, an identity value associated with a second bearer for operating in dual connectivity with the user device, wherein data carried on the second bearer is split at the second access point; and
using the allocated identity value to configure the user device with the second bearer via the first access point.

2. A method according to claim 1, wherein allocating the identity value associated with the second bearer comprises determining an identity value distinct from the identity value associated with the first bearer and the identity value associated with the second bearer.

3. A method according to claim 1, wherein using the allocated identity value for configuring the user device with the second bearer comprises providing an indication of the allocated identity value to the first access point for use in configuring the user device with the second bearer.

4. A method according to claim 1, wherein using the allocated identity value to configure the user device with the second bearer comprises providing an indication of the allocated identity value and the associated bearer to the user device.

5. A method according to claim 1, wherein the identity values comprise logical channel identity values.

6. A method according to claim 5, wherein each of the respective first and second bearer is associated with a respective security key.

7. A method according to claim 1, wherein data carried on the respective first bearer is split at the first access point.

8. A method according to claim 1, wherein the respective first bearer is one of a master cell group bearer and a secondary cell group bearer.

9. A method according to claim 1, wherein the first access point is a master nodeB and the second access point is a secondary NodeB.

10. A method comprising:
providing, from a first access point to a second access point, bearer identity information, said bearer identity information comprising an indication of at least one identity value associated with a respective first bearer of a user device, the user device capable of operating using dual connectivity mode;
receiving, from the second access point, an indication of an allocated identity value associated with a second bearer, the identity value associated with the second bearer allocated in dependence on the bearer identity information, wherein data carried on the second bearer is split at the second access point; and
using the allocated identity value to configure the user device with the second bearer.

11. A method according to claim 10, wherein using the allocated identity value to configure the user device with the second bearer comprises determining whether the allocated identity value is distinct from the identity value associated with the respective first bearer.

12. A method according to claim 10, wherein using the allocated identity value to configure the user device with the second bearer comprises providing an indication of the allocated identity value and the associated bearer to the user device.

13. A method according to claim 10, wherein the identity values comprise logical channel identity values.

14. A method according to claim 13, wherein each of the respective first and second bearer is associated with a respective security key.

15. A method according to claim 10, wherein data carried on the respective first bearer is split at the first access point.

16. A method according to claim 10, wherein the respective first bearer is one of a master cell group bearer and a secondary cell group bearer.

17. A method according to claim 10, wherein the first access point is a master nodeB and the second access point is a secondary NodeB.

18-19. (canceled)

20. An apparatus comprising:
at least one processor and at least one memory including a computer program code, the at least one memory and the computer program code configured to, with the at least one processor, cause the apparatus at least to:
receive, from a first access point at a second access point, bearer identity information, said bearer identity information comprising an indication of at least one identity value associated with a respective first bearer of a user device, the user device capable of operating using dual connectivity mode;
allocate, in dependence on the bearer identity information, an identity value associated with a second bearer for operating in dual connectivity with the user device, wherein data carried on the second bearer is split at the second access point; and
use the allocated identity value to configure the user device with the second bearer via the first access point.

21. An apparatus comprising:
at least one processor and at least one memory including a computer program code, the at least one memory and the computer program code configured to, with the at least one processor, cause the apparatus at least to:
provide, from a first access point to a second access point, bearer identity information, said bearer identity information comprising an indication of at least one identity value associated with a respective first bearer of a user device, the user device capable of operating using dual connectivity mode;
receive, from the second access point, an indication of an allocated identity value associated with a second bearer, the identity value associated with the second bearer allocated in dependence on the bearer identity information, wherein data carried on the second bearer is split at the second access point; and
use the allocated identity value to configure the user device with the second bearer.
